(19) United States
(12) Patent Application Publication
(10) Pub. No.: US 2018/0225201 A1
(43) Pub. Date: Aug. 9, 2018

(54) PRESERVING VOLATILE MEMORY ACROSS A COMPUTER SYSTEM DISRUPTION

(71) Applicant: HEWLETT PACKARD ENTERPRISE DEVELOPMENT LP, Houston, TX (US)

(72) Inventors: Thierry FEVRIER, Gold River, CA (US); David C VALDEZ, Houston, TX (US); Patrick A RAYMOND, Houston, TX (US); Justin Haanbyull PARK, Houston, TX (US); David P MOHR, Spring, TX (US); Hai Ngoc NGUYEN, Spring, TX (US); Michael Edward MCGOWEN, Houston, TX (US)

(21) Appl. No.: 15/746,841

(22) PCT Filed: Jul. 23, 2015
(86) PCT No.: PCT/US2015/041815

§ 371 Date: Jan. 23, 2018

(51) Int. Cl. G06F 12/0804

(52) U.S. Cl. CPC G06F 12/0804; G06F 2212/1032

(57) ABSTRACT

A method for preserving volatile memory across a computer system disruption includes identifying a set of volatile memory. The set of volatile memory represents a portion of data in volatile memory to preserve during a system disruption. The method includes receiving a system event. The system event indicates that a computer system disruption will occur and that the set of volatile memory is to be written to a stable storage device. The method includes writing the set of volatile memory to the stable storage device to create a stored data set.

### BACKGROUND

A computer system includes a number of computer program processes. When a computer program process begins to execute, the computer program process establishes data in memory to perform a computer implemented task. The computer program process operates on the data set to perform the computer implemented task. The data set stores information for the computer program process.

### BRIEF DESCRIPTION OF THE DRAWINGS

The accompanying drawings illustrate various examples of the principles described herein and are a part of the specification. The examples do not limit the scope of the claims.

FIG. 1 is a diagram of preserving volatile memory across a computer system disruption according to one example of the principles described herein.

FIG. 2 is a diagram of preserving volatile memory across a computer system disruption according to another example of the principles described herein.

FIG. 3 is a diagram of a system for preserving volatile memory across a computer system disruption according to yet another example of the principles described herein.

FIG. 4 is a flowchart of a method for preserving volatile memory across a computer system disruption according to one example of the principles described herein.

FIG. 5 is a flowchart of a method for preserving volatile memory across a computer system disruption according to one example of the principles described herein.

FIG. 6 is a diagram of computer program product for preserving volatile memory across a computer system disruption, according to one example of the principles described herein.

Throughout the drawings, identical reference numbers designate similar, but not necessarily identical, elements.

### DETAILED DESCRIPTION

A computer program process represents a set of code, that, when executed by a processor, performs a particular task. The computer program process operates on a data set. The data set serves to track state for the computer program process. When a computer program process begins execution, it establishes the data set. Establishing the data set may take time, slowing down the startup and execution of the computer program process. Further, the data set may grow and be modified as the computer program process runs. A large data set takes more time to establish, making the task performed by the computer program process unavailable for a period of time. Storing the data set on stable storage causes poor read time, lowering the performance of the computer program process.

A delay in the availability of the computer program process may interfere with the availability of services provided by a computing device. Several different approaches have been implemented to reduce the persistence and unavailability of data, as well as to reduce the startup costs of computer program processes. In one example, a computer program process may write data associated with the computer program process to a stable storage device. Writing data to stable storage takes more time than writing data to volatile memory. This approach preserves the data, but the computer program process incurs processing overhead of writing data to the stable storage device. The processing overhead may slow down a system. In another example, a computing device uses non-volatile RAM (NVRAM), allowing a computer program process to appear to store data in volatile memory. NVRAM is more expensive than volatile memory, making this solution costly. In yet another example, the system copies volatile memory to stable storage when a system outage occurs. When the system recovers from the outage, it restores the copy of stable storage to volatile memory. This approach incurs an overhead for moving data from volatile memory to stable storage. Further, this approach may restore data that contributed to a system outage.

Accordingly, the present specification describes a system and method for preserving volatile memory across a computer system disruption. The system and method allow a computer program process to identify data in volatile memory. The identified data is preserved across system disruptions. The system and method allows the computer program process to preserve a portion of the data without periodically writing the data to stable storage. The system and method allows the computer program process to treat the memory as volatile memory. The computer program process preserves data that is less likely to cause a system disruption.

The present disclosure describes a method for preserving volatile memory across a computer system disruption. According to the method, a set of volatile memory is identified. The set of volatile memory represents a portion of data in volatile memory to preserve during a system disruption. According to the method, a system event is received. The system event indicates that a computer system disruption will occur and that the set of volatile memory is to be written to a stable storage device. According to the method, the set of volatile memory is written to the stable storage device to create a stored data set.

The present disclosure describes a system for preserving volatile memory across a computer system disruption. The system includes a processor, memory communicatively coupled to the processor, stable storage communicatively coupled to the processor, and a memory preservation system. The memory preservation system includes an identify engine, a receive engine, a write engine, a restore engine, and a notify engine. The identify engine identifies a set of volatile memory. The set of volatile memory represents a portion of data in memory to preserve during a system disruption. The receive engine receives a system event. The system event indicates that a computer system disruption will occur and that the set of volatile memory is to be written to a stable storage device. The write engine writes the set of volatile memory to the stable storage device to create a stored data set. The restore engine restores, when a system recovers, the stored data set to volatile memory. The notify engine notifies a data consumer that the stored data set is available for use.

The present disclosure describes a computer program product for preserving volatile memory across a computer system disruption. The computer program product includes a non-transitory tangible computer readable storage medium. The tangible computer readable storage medium includes computer readable program code. The computer readable program code includes program instructions that, when executed, cause a processor to identify a set of volatile memory. The set of volatile memory represents a portion of data in volatile memory to preserve during a system disruption. The computer readable program code includes program instructions that, when executed, cause a processor to receive a system event. The system event indicates that a computer system disruption will occur and that the set of volatile memory is to be written to a stable storage device. The computer readable program code includes program instructions that, when executed, cause a processor to write the set of volatile memory to the stable storage device to create a stored data set.

The system and method described allow data to be used while it is written in volatile memory while the data is preserved across a system disruption. Portions of the volatile memory are written to stable storage. The system and method allow the system to benefit of storing data in stable storage without the overhead of moving all data to stable storage and without the expense of using technologies such as NVRAM.

As used in the present specification and in the appended claims, the term “memory” refers to random access memory. Memory may lose the data stored in the memory when power to the memory is removed. Power to the memory is removed when the system restarts. Memory that changes frequently and loses state when power is removed is referred to as “volatile memory.”

As used in the present specification and in the appended claims, the term “stable storage” refers to a data storage mechanism that maintains data when power is removed. Examples of stable storage devices include a hard disk drive, flash memory, and non-volatile random access memory (NVRAM).

As used in the present specification and in the appended claims, the term “portion” refers to a part of a set, but may not be all of the set. For example, a portion of memory represents a part, but not all, of memory.

As used in the present specification and in the appended claims, the term “disruption” refers to a disturbance or problem that interrupts the activity on a computing device. A disruption may cause a disturbance in a portion of the activity on a computing device. A disruption may cause a disturbance in all activity on a computing device.

As used in the present specification and in the appended claims, the term “system event” refers to a happening on a computing device that affects a number of activities on the computing device. A system event includes a disruption. A system event may include activity that does not cause a disruption. For example, a backup event may be a system event.

As used in the present specification and in the appended claims, the term “recover” refers to a computer device returning to a functional state. A recovery indicates that a computing device is functioning. A computing device may continue to establish data or processes after recovering to reach a state that is similar to pre-disruption state.

As used in the present specification and in the appended claims, the term “primary power source” refers to a power source used by a computing device during normal operation. The primary power source may be an alternating current power source. The primary power source may be a battery that is used during normal operation.

As used in the present specification and in the appended claims, the term “auxiliary power source” refers to a reserved power source used in addition to the primary power source. The auxiliary power source provides power to a computing device when there is a disruption in the primary power source. The auxiliary power source may be a battery associated with the computing device. The auxiliary power source may be a reserve amount of power in a battery used as a primary power source.

As used in the present specification and in the appended claims, the term “power outage” refers to an interruption or disruption in the primary power source. A system experiencing a power outage may operate for a period of time using an auxiliary power source.

As used in the present specification and in the appended claims, the term “system shutdown” refers to a series of operations on a computing device to quiesce activity on a system. A system shutdown may intentionally shut off the primary power source.

As used in the present specification and in the appended claims, the term “system outage” refers to a pervasive disruption of activity on a computing device. A system outage affects any activity on a computing device.

As used in the present specification and in the appended claims, the term “system failure” refers to an unexpected and unanticipated system event, frequently causing a system outage, due to an error on the computing device. A system failure may be caused by a failure of hardware on the system device. A system failure may be caused by a software error on the computing device.

As used in the present specification and in the appended claims, the term “system sleep” refers to a power saving state that a computing device may enter when not in use. When a computing device enters sleep mode, some parts of the computing device do not receive power, while memory receives enough power to maintain data.

As used in the present specification and in the appended claims, the term “system hibernation” refers to a power down state on a computing device wherein the computing device retains its state. When a computing device enters hibernation, the computing device saves the contents of memory to a stable storage device. Upon resumption, the computing device appears to be in the same state as before entering system hibernation.

Yet further, as used in the present specification and in the appended claims, the term “a number of” or similar language may include any positive number including one to infinity; zero not being a number, but the absence of a number.

In the following description, for purposes of explanation, numerous specific details are set forth in order to provide a thorough understanding of the present systems and methods. It will be apparent, however, to one skilled in the art, that the present apparatus, systems, and methods may be practiced without these specific details. Reference in the specification to “an example” or similar language means that a particular feature, structure, or characteristic described in connection with that example is included as described, but may not be included in other examples.

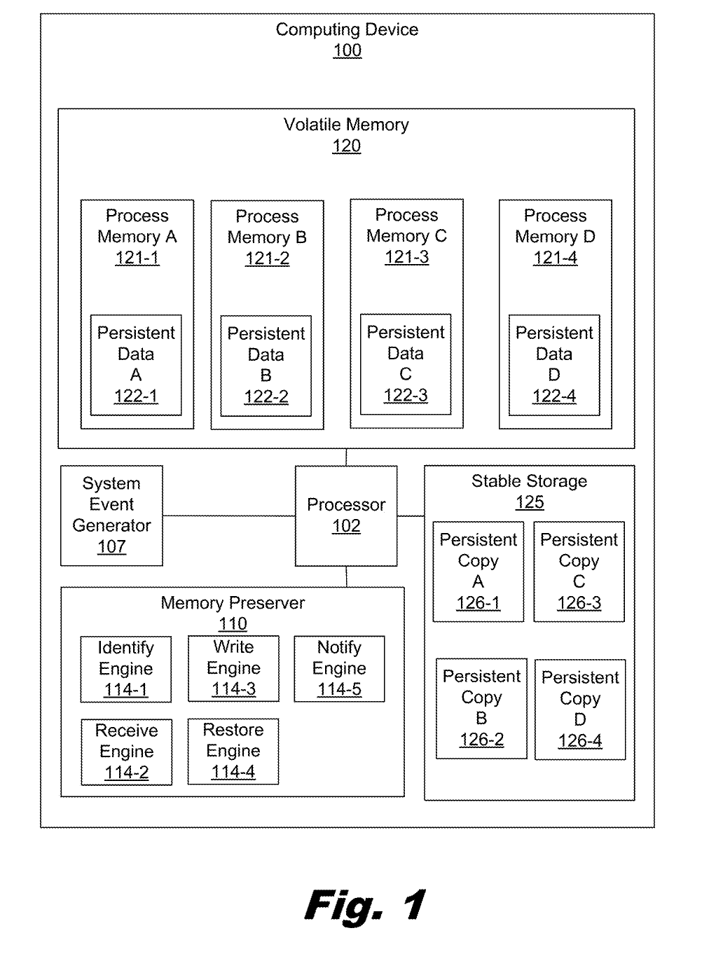

Referring now to the figures, FIG. 1 is a diagram of a system for preserving volatile memory across a computer system disruption, according to one example of the principles described herein. As illustrated, a computing device (100) includes a processor (102), volatile memory (120), stable storage (125), a system event generator (107), and a memory preserver (110). The volatile memory (120) has a number of process memory (121) segments associated with a number of processes. A process memory (121) segment has persistent data segments (122). The persistent data segments (122) are established to preserve the persistent data segments (122) across system disruptions. The engines (114) in the memory preserver (110) cause the processor (102) to write the persistent data (122) to the stable storage (125).

A number of processes use data stored in process memory (121) in volatile memory (120), The process memory (121) represents data associated with the process to store a state associated with the process. A process may include a portion of process memory (121) that persists across system disruptions. As illustrated, process memory A (121-1) includes a portion of data, persistent data. A (122-1), to persist across a system disruption.

When a system event generator (107) notifies the processor (102) that a system event occurs, the processor (102) executes computer program code to determine whether a system disruption will occur. When the processor determines a system event will cause a system disruption, the memory preserver (110) acts to preserve portions of the volatile memory (120) using stable storage (125). When the system is restored, the memory preserver (110) restores the persistent copy (126) in stable storage (125) to volatile memory (120).

The memory preserver (110) further includes a number of engines used in the implementation of the memory preserver (110). The various engines within the memory preserver (110) include executable program code that may be executed by a processor (102) separately. In this example, the various engines may be stored as separate computer program products. In another example, the various engines within the memory preserver (100) may be combined within a number of computer program products; each computer program product including a number of engines. An engine may comprise a combination of hardware and computer program code. The engines (114) may include a processor to, when executed by the processor, cause a task to occur. The memory preserver (110) includes an identify engine (114-1), a receive engine (114-2), a write engine (114-3), a restore engine (114-4), and a notify engine (114-5).

The memory preserver (110) includes an identify engine (114-1) to identify a set of volatile memory. The set of volatile memory represents a portion of data in memory to preserve during a system disruption. Volatile memory loses state when power is removed. Volatile memory that is preserved is moved to a non-volatile storage location. As illustrated, the memory preserver (110) identifies persistent data A (122-1), persistent data B (122-2), persistent data C (122-3) and persistent data D (122-4).

The memory preserver (110) includes a receive engine (114-2) to receive a system event. The system event indicates that a computer system disruption will occur and that the set of volatile memory is to be written to a stable storage device. The system event may be generated by a system event generator (107). In one example, the system event generator (107) may be a hardware unit on the computing device (100). In another example, the system event generator (107) may be part of software executed on the computing device. In still another example, the system event generator (107) may be a combination of hardware and software. A system event may be a loss of power from a primary power source. A system event may be one of a power outage, a system shutdown, a system failure, a system sleep, or a system hibernation.

The memory preserver (110) includes a write engine (114-3) to write the set of volatile memory to the stable storage device to create a stored data set. The write engine (114-3) may write the amount of memory that may be stored under an auxiliary power source. The write engine (114-3) may act based on an amount of power measured in the auxiliary power source. In one example, a computing device operates for a period of time under auxiliary power. The auxiliary power may be a battery allowing the computing device to continue operation. As the computing device continues operation, the power stored for auxiliary power is depleted. When the auxiliary power reaches a configured amount, the system shuts down. The memory preserver (110) may write the set of volatile memory as part of the shutdown process under auxiliary power.

The memory preserver (110) includes a restore engine (114-4) to restore, when a system recovers, the stored data set to volatile memory. The restore engine (114-4) reads the persistent copy of the data from stable storage (125) and writes the copy of the data to volatile memory (120). In one example, the restore engine (114-4) reads persistent data A (126-1) and copies the data to the location of persistent data A (122-1). The restore engine (114-4) allows a process to continue to work with the data in volatile memory (120).

The memory preserver (110) includes a notify engine (114-5) to notify a data consumer that the stored data set is available for use. The code, when executed on the processor (102) may then operate on the persistent data (122).

An overall example according to FIG. 1 will now be described. A number of process memory segments include process memory A (121-1), process memory B (121-2), process memory C (121-3), and process memory D (121-4). Each process memory (121) segment includes persistent data (122). The persistent data (122) represents data that is identified to persist across a system disruption. The data may be identified by a number of sources, such as a user identifying the data, a system configuration identifying the data, or similar identification of the data, to persist across a system disruption.

The identify engine (114-1) identifies persistent data A (122-1), persistent data B (122-2), persistent data C (122-3), and persistent data D (122-4) as data to be moved to stable storage (125). The persistent data (122) represents data that will be available after the system disruption. Volatile memory (120) that is not persistent data (122) will not be available after the disruption. In one example, the persistent data (122) may represent data in a database that is used to store a set of information that is being used. Other data, such as program variables or memory addresses, are not identified to persist across a system disruption. By preserving data, such as a database, but not preserving program variables and memory addresses, less data is preserved across a system outage. This allows the system to recover in less time as less data is being preserved. Additionally, when the program variables do not persist across system disruptions, it reduces the probability that errors in the program variables will persist across a system disruption. In another example, allocated data, such as user information, is identified to persist across a system disruption. Stack data, such as values of arguments to a function, are not identified. Allocated data may be more likely to be valid after a system disruption. By identifying allocated data to persist across a system disruption, data that is relevant may persist across disruptions, as where data that is less likely to be relevant after a system disruption. In still another example, data that is shared between computer program processes persists across system outages. An individual process is less likely to be solely responsible for data that is shared between processes. Data that is shared between processes may persist across a system disruption and be transparently restored and used by a process after the system disruption. Additional benefits may be observed as a result of selectively identifying data that is to persist across system disruptions.

The receive engine (114-2) receives a notification from the system event generator (107) that a system event is occurring. In this example, the system event generator (107) generates an event indicating that the system has experienced a terminal fault and will be rebooting.

The write engine (114-3) writes the persistent data (122) to stable storage (125) as a persistent copy (126). Persistent data A (122-1) is written as persistent copy A (126-1). Persistent data B (122-2) is written as persistent copy B (126-2). Persistent data C (122-3) is written as persistent copy C (126-3). Persistent data D (122-4) is written as persistent copy D (126-4). The persistent copies (126) in stable storage (125) maintain the data even when power is removed.

After the system disruption, the restore engine (114-4) restores the persistent data copy (126) to volatile memory (120). The restore engine (114-4) reads the persistent data from stable storage (125) and restores the data to volatile memory (120). Persistent copy A (126-1) is restored to the location of persistent data A (122-1). Persistent copy B (126-2) is restored to the location of persistent data B (122-2). Persistent copy C (126-3) is restored to the location of persistent data C (122-3). Persistent copy D (126-4) is restored to the location of persistent data D (122-4).

The notify engine (114-5) notifies a number of processes that the persistent data (122) has been restored to volatile memory (120). The number of processes are consumers of the persistent data (122) that has been restored. The notification includes sending a message to a process that persistent data is ready to use.

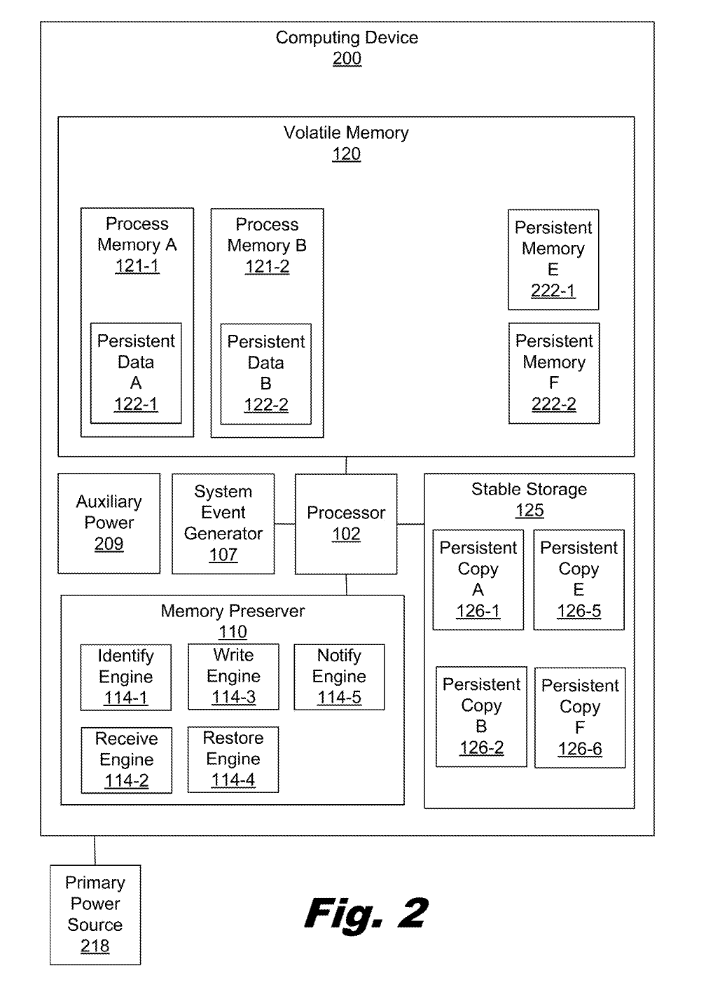

FIG. 2 is a diagram of a system for preserving volatile memory across a computer system disruption, according to another example of the principles described herein. As illustrated, a computing device (200) includes a processor (102), volatile memory (120), stable storage (125), a system event generator (107), and a memory preserver (110). As described above, the volatile memory (120) has a number of process memory (121) segments associated with a number of processes. As described above, the engines (114) in the memory preserver (110) cause the processor (102) to write the persistent data (122) to the stable storage (125). The computing device (200) includes a primary power source (218) and an auxiliary power source (209).

An example according to FIG. 2 will now be described. The memory preserver (110) acts to preserve persistent data (122) and persistent memory (123) without changes to a process. The memory preserver (110), in this example, acts as part of a computer operating system running on the computing device (200). The memory preserver acts without a program change to the process associated with the memory being preserved. As described above, the identify engine (114-1) identifies persistent data A (122-1) and persistent data B (122-2) to persist across a system disruption. Further, persistent memory E (222-1) and persistent memory F (222-2) are identified to persist across a system disruption. The persistent data (122) is associated with process memory (121). For example, the persistent data (122) may be data allocated as part of a processes memory address space. The persistent memory (222) is not part of a processes memory. The persistent memory may be a memory segment shared by a number of processes, may be a memory segment associated with the operating system, or other types of memory that are not attached to process memory. For example, the persistent memory (222) may be allocated as a shared memory segment outside of a process that is shared by a plurality of processes. Persistent memory (222) is moved to stable storage (125) by the memory preserver (110) in the same manner as the persistent data (122).

The receive engine (114-2) receives a system event from the system event generator (107). In this example, the system event indicates that the primary power source (218) has failed and that the computing device (200) is running on auxiliary power (219). The computing device has enough auxiliary power to shutdown the computing device (200), but the volatile memory (120) will lose power causing data in volatile memory (120) be lost. The memory preserver (110) will preserve the memory until the system recovers from the loss of the primary power source (218).

While using the auxiliary power (219), the write engine (214-3) writes the persistent data (122) and the persistent memory (222) to stable storage (125). Persistent data A (122-1) is copied as persistent copy A (126-1). Persistent data B (122-2) is copied as persistent copy B (126-2). Persistent memory E (222-1) is copied as persistent copy E (126-5). Persistent memory F (222-2) is copied as persistent copy F (126-6). The write engine (214-3) completes the write while using auxiliary power (219).

When the primary power source (218) is restored, the computing device (200) recovers. The computing device (200) causes the system to execute software on the processor (102). The computing device (200) uses the memory preserver (110) to restore memory after a disruption. The restore engine (114-4) restores the persistent copies (126) to volatile memory (120). The restore engine (114-4) copies persistent copy A (126-1) to a location for persistent data A (122-1). The restore engine (114-4) copies persistent copy B (126-2) to a location for persistent data B (122-2). The restore engine (114-4) copies persistent copy E (126-5) to the location for persistent memory E (222-1). The restore engine (114-4) copies persistent copy F (126-6) to the location for persistent memory F (222-2).

The notify engine (114-5) notifies a data consumer that the persistent data is in volatile memory and is ready to use. The data consumer may use the data in volatile memory.

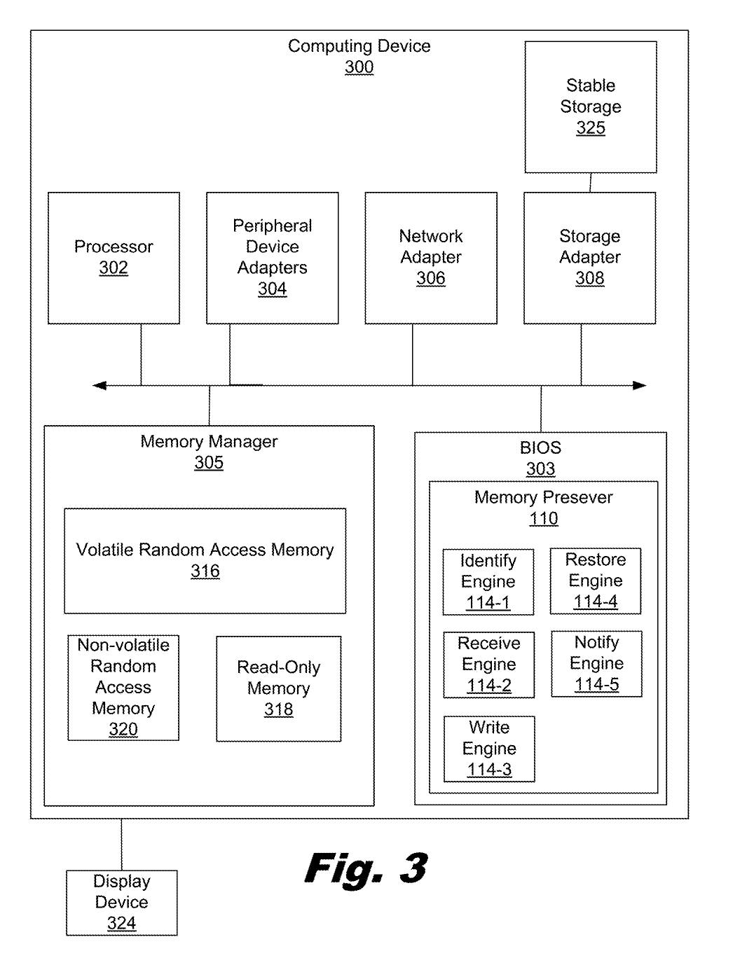

Referring now to the next figure, FIG. 3 is a diagram of a system for preserving volatile memory across a computer system disruption, according to yet another example of the principles described herein. As illustrated, the memory preserver (110) is part of the Basic Input/Output system (BIOS). The memory preserver (110) acts to preserve volatile memory in the computing system (300) when a system event occurs that causes a disruption.

The computing system (300) may be implemented in an electronic device. Examples of electronic devices include servers, desktop computers, laptop computers, personal digital assistants (PDAs), mobile devices, smartphones, gaming systems, and tablets, or other electronic devices. The computing system (300) of FIG. 3 may be part of a general purpose computer. However, in alternative examples, the computing system (300) is part of an application specific integrated circuit.

In some examples, the processor (302) and the memory preserver (110) are located within the same physical component, such as a server or a network component. The memory preserver (110) may be part of the physical component's main memory, caches, registers, non-volatile memory, or elsewhere in the physical component's memory hierarchy. Alternatively, the memory preserver (110) may be in communication with the processor (302) over a network. Further, the data structures may be accessed from a remote location over a network connection while the programmed instructions are located locally. Thus, the computing system (300) may be implemented on a user device, on a server, on a collection of servers, or combinations thereof.

The computing system (300) may be utilized in any data-processing scenario, including stand-alone hardware, mobile applications, a computing network, or combinations thereof. Further, the computing system (300) may be used in a computing network, a public cloud network, a private cloud network, a hybrid cloud network, other forms of networks, or combinations thereof. In one example, the methods provided by the computing system (300) are provided as a service over a network by, for example, a third party. In this example, the service may include, for example, the following: a Software as a Service (SaaS) hosting a number of applications; a Platform as a Service (Paas) hosting a computing platform including, for example, operating systems, hardware, and storage, among others; an Infrastructure as a Service (IaaS) hosting equipment such as, for example, servers, storage components, network, and components, among others; application program interface (API) as a service (APIaaS), other forms of network services, or combinations thereof. The present systems may be implemented on one or multiple hardware platforms, in which the modules in the system can be executed on one, or across multiple, platforms. Such modules can run on various forms of cloud technologies and hybrid cloud technologies or offered as a SaaS (Software as a service) that can be implemented on or off the cloud. In another example, the methods provided by the computing system (300) are executed by a local administrator.

To achieve its desired functionality, the computing system (300) includes various hardware components. Among these hardware components may be a number of processors (302), a memory preserver (110), a number of network adapters (306), a number of peripheral device adapters (304), and a number of storage adapters (308). These hardware components may be interconnected through the use of a number of busses and/or network connections. In one example, the processor (302), memory preserver (314), peripheral device adapters (304), network adapter (306), and storage adapter (308) may be communicatively coupled via a bus.

The processor (302) may include the hardware architecture to retrieve executable code from the memory preserver (110) and execute the executable code. The executable code may, when executed by the processor (302), cause the processor (302) to implement at least the functionality of preserving volatile memory across a system disruption. The functionality of the computing system (300) is in accordance to the methods of the present specification described herein. In the course of executing code, the processor (302) may receive input from and provide output to a number of the remaining hardware units.

The memory manager (305) may interface with various types of memory, including volatile and non-volatile memory. For example, the memory manager (305) of the present example may include volatile random access memory (volatile RAM) (316), read-only memory (ROM) (318), and non-volatile random access memory (non-volatile RAM) (320). Many other types of memory may also be utilized, and the present specification contemplates the use of many varying type(s) of memory as may suit a particular application of the principles described herein. In certain examples, different types of memory may be used for different data storage needs. For example, in certain examples the processor (302) may boot from read only memory (ROM) (318), maintain nonvolatile storage in the non-volatile RAM (non-volatile RAM) (320), and execute program code stored in volatile random access memory (volatile RAM) (316).

Generally, the memory manager (305) may include a computer readable medium, a computer readable storage medium, or a non-transitory computer readable medium, among others. For example, the memory manager (305) may include an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a volatile random access memory (RAM) (316), a read-only memory (ROM) (318), non-volatile RAM (NVM) (320) an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store computer usable program code for use by, or in connection with, an instruction execution system, apparatus, or device. In another example, a computer readable storage medium may be any non-transitory medium that can contain or store a program for use by, or in connection with, an instruction execution system, apparatus, or device.

The adapters (304, 306, 308) in the computing system (300) enable the processor (302) to interface with various other hardware elements, external and internal to the computing system (300). For example, the peripheral device adapters (304) may provide an interface to input/output devices, such as, for example, a display device (324), a mouse, hard disk drive (HDD), solid state drive (SSD) or a keyboard. The peripheral device adapters (304) may also provide access to other external devices, such as an external storage device, a number of network devices such as, for example, servers, switches, and routers, client devices, other types of computing devices, and combinations thereof. The display device (324) may be provided to allow a user of the computing system (300) to interact with and implement the functionality of the computing system (300). The network adapter (306) may provide an interface to other computing devices within, for example, a network, thereby enabling the transmission of data between the computing system (300) and other devices located within the network.

The computing system (300) includes a memory preserver (110). The memory preserver (110) may include any memory capable of storing data such as programmed instructions or data structures used by the computing device (300). The memory preserver (110) may store data such as executable program code that is executed by the processor (302) or other processing device. As will be discussed, the memory preserver (110) may specifically store computer code representing a number of applications that the processor (302) executes to implement at least the functionality described herein.

The memory preserver (310) includes a number of engines. The various engines within the computing system (300) include executable program code that may be executed separately. In this example, the various engines may be stored as separate computer program products. In another example, the various engines within the computing system (300) may be combined within a number of computer program products; each computer program product including a number of engines

As described above, the identify engine (114-1) identifies a set of volatile memory. The set of volatile memory represents a portion of data in memory to preserve during a system disruption.

As described above, the receive engine (114-2) receives a system event. The system event indicates that a computer system disruption will occur and that the set of volatile memory is to be written to a stable storage device. As described above, the write engine (114-3) writes the set of volatile memory to the stable storage device to create a stored data set. As described above, the restore engine (114-4) restores, when a system recovers, the stored data set to volatile memory. As described above, the notify engine (114-5) notifies a data consumer that the stored data set is available for use.

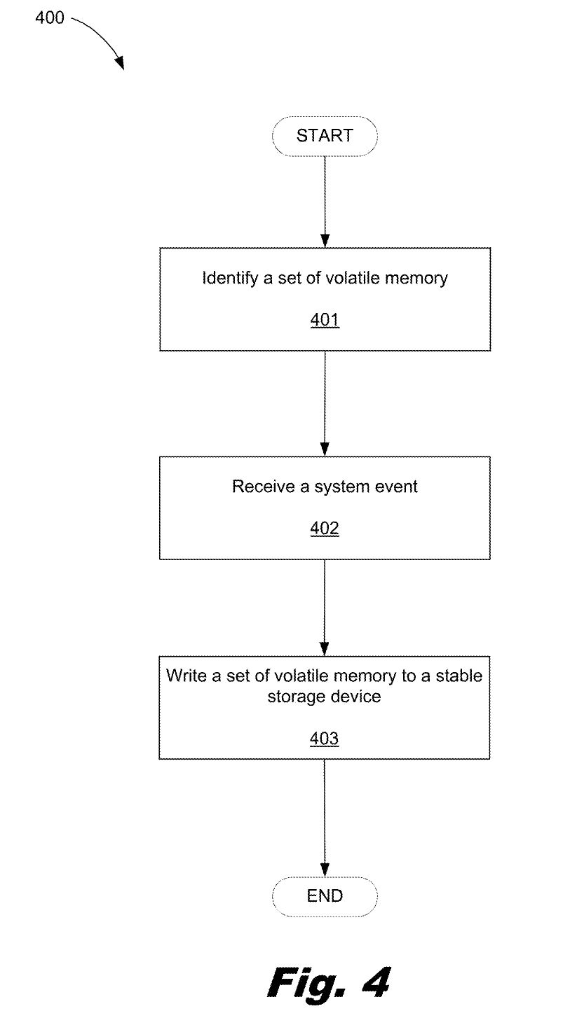

FIG. 4 is a flowchart of a method (400) for preserving volatile memory across a computer system disruption according to one example of the principles described herein. The method (400) includes identifying (block 401) a set of volatile memory. The set of volatile memory represents a portion of data in volatile memory to preserve during a system disruption. The set of volatile memory may be a proper subset of memory.

The method (400) also includes receiving (block 402) a system event. The system event indicates that a computer system disruption will occur and that the set of volatile memory is to be written to a stable storage device. The system event may be a system controlled event, such as one of a system shutdown, a system sleep, or a system hibernation. The system event may be an event that the system does not control, such as a power outage or a system failure. The system event may be a notification of an amount of auxiliary power available to write data. For example, a system event may notify the method of an amount of auxiliary power available to store data in stable storage.

The method also includes (block 403) writing the set of volatile memory to the stable storage device to create a stored data set. Writing (block 403) the set of volatile memory to the stable storage may write an amount of memory that may be stored under auxiliary power source. Writing (block 403) the set of volatile memory to stable storage may be performed based on an amount of power measured in the auxiliary power source.

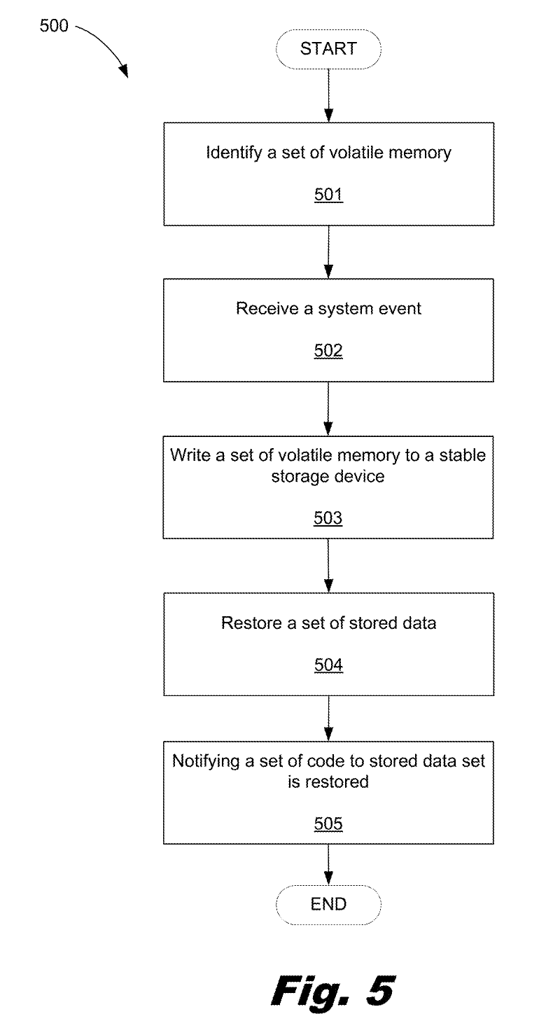

FIG. 5 is a flowchart of a method (500) for preserving volatile memory across a computer system disruption according to one example of the principles described herein. As described in FIG. 4, the method (500) includes identifying (block 501) a set of volatile memory, receiving (block 502) a system event, and writing (block 503) the set of volatile memory to the stable storage device to create a stored data set.

The method (500) also includes restoring (block 504) the stored data set to volatile memory when the system recovers. The stored data set may be copied or moved from stable storage back to volatile RAM. When the stored data set is in volatile memory, computer program code may use the data. The stored data set maintains the state of the data across the system disruption.

The method (500) includes notifying (block 504) a set of code that the stored data set is available for use. The notifying (block 505) may consist of a message using a signal, inter-process communication, or similar active methods of communication. The notifying (block 505) may consist of setting a value that is monitored by a consumer of the data to indicate that the data is ready to be used. The notifying (block 505) notifies the consumer of the data that data is available to be consumed. The notifying (block 505) may not communicate that the data was placed in stable storage and restored to volatile memory.

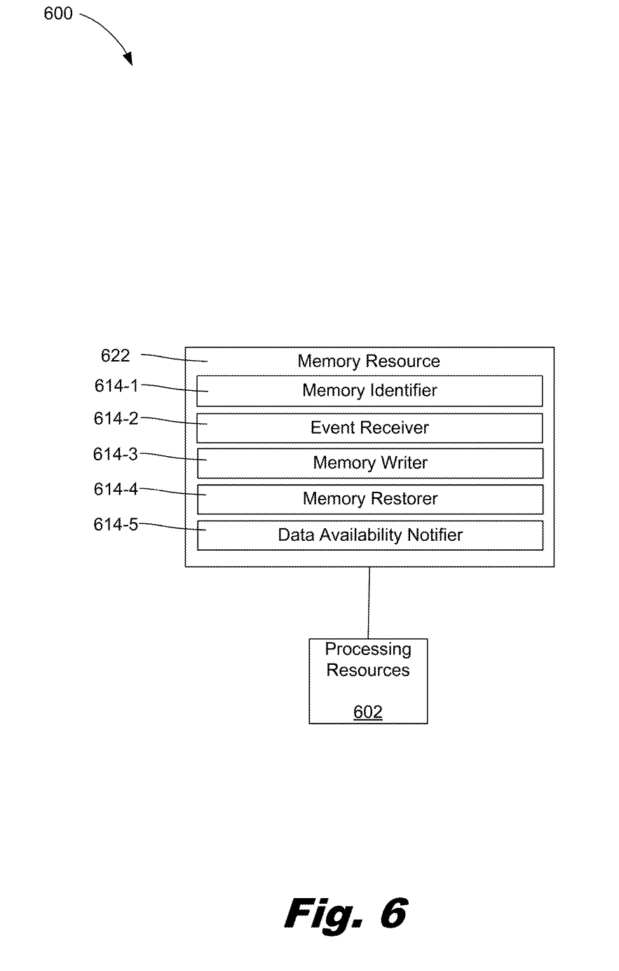

FIG. 6 is a diagram of an example of a memory preserver (600), according to the principles described herein. In this example, the memory preserver (600) includes processing resources (602) that are in communication with memory resources (622). The processing resources (602) include at least one processor and other resources used to process programmed instructions. The memory resource (622) represents any memory capable of storing data, such as programmed instructions or data structures used by the memory preserver (600). The programmed instructions shown stored in the memory resources (622) include a memory identifier (614-1), an event receiver (614-2), a memory writer (614-3), memory restorer (614-4), and a data availability notifier (614-5).

The memory resources (622) include a computer readable storage medium that contains computer readable program code to cause tasks to be executed by the processing resources (602). The computer readable storage medium may be a tangible and/or physical storage medium. The computer readable storage medium may be any appropriate storage medium that is not a transmission storage medium. A non-exhaustive list of computer readable storage medium types includes non-volatile memory, volatile memory, random access memory, write only memory, flash memory, electrically erasable programmable read only memory, other types of memory, or combinations thereof.

The memory identifier (614-1) represents programmed instructions that, when executed, cause the processing resource (602) to identify a set of memory to be preserved across a disruption of services provided by a computing device. The disruption may cause a loss of data or state. The memory identified volatile memory that could lose state. The memory identified represents a subset of volatile memory.

The event receiver (614-2) represents programmed instructions that, when executed, cause the processing resource (602) to receive an event. The event may be a notification via an event handler. The event may be produced by an exception to normal execution of computer code on a processing resource (602).

The memory writer (614-3) represents programmed instructions that, when executed, cause the processing resource (602) to write data stored in volatile memory to a stable storage device. The data written to the stable storage device is the data identified by the memory identifier (614-2).

The memory restorer (614-4) represents programmed instructions that, when executed, cause the processing resource (602) to restore the data that was written to stable storage to volatile memory.

The data availability notifier (614-4) represents programmed instructions that, when executed, cause the processing resource (602) to notify consumers of data that the data has been restored to volatile memory and is ready for use.

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general purpose computer, special purpose computer, or other programmable data processing apparatus to produce a machine, such that the computer usable program code, when executed via, for example, the processor (FIG. 2, 202) of the computing system (FIG. 2, 200) or other programmable data processing apparatus, implements the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The preservation of a subset of volatile memory across disruptions in system availability allows a system to maintain the availability of data. The preservation of a subset of data consumes less time than preserving all volatile memory. The preservation of a subset of volatile memory allows a system to consume less auxiliary power while preserving data. Additionally, the preservation of a subset of volatile memory allows identified data to be preserved while non-identified data is reset. The selective preservation of data reduces the risk of preserving data that may have caused the disruption

The preceding description has been presented to illustrate and describe examples of the principles described. This description is not intended to be exhaustive or to limit these principles to any precise form disclosed. Many modifications and variations are possible in light of the above teaching.

What is claimed is:

1. A computer implemented method for preserving volatile memory across a computer system disruption, the method comprising:
identifying a set of volatile memory, the set of volatile memory representing a portion of data in volatile memory to preserve during a system disruption;
receiving a system event, the system event indicating that a computer system disruption will occur and that the set of volatile memory is to be written to a stable storage device; and
writing the set of volatile memory to the stable storage device to create a stored data set.

2. The method of claim 1, further comprising:
when a system recovers, restoring the stored data set to volatile memory; and
notifying a data consumer that the stored data set is available for use.

3. The method of claim 1, wherein the set of volatile memory identified is associated with a computer process.

4. The method of claim 1, wherein writing the set of volatile memory to the stable storage writes an amount of memory that may be stored under auxiliary power source.

5. The method of claim 4, wherein writing the set of volatile memory to stable storage begins writing based on an amount of power measured in the auxiliary power source.

6. The method of claim 1, wherein the system event is one of a power outage, a system shutdown, a system failure, a system sleep, or a system hibernation.

7. The method of claim 1, wherein the system event is a notification of an amount of auxiliary power available to write data.

8. A system for preserving volatile memory cross a computer system disruption, the system comprising:
a processor;
memory communicatively coupled to the processor;
stable storage communicatively coupled to the processor; and
a memory preservation system, the memory preservation system comprising:
an identify engine, to identify a set of volatile memory, the set of volatile memory representing a portion of data in memory to preserve during a system disruption;
a receive engine, to receive a system event, the system event indicating that a computer system disruption will occur and that the set of volatile memory is to be written to a stable storage device;
a write engine, to write the set of volatile memory to the stable storage device to create a stored data set;
a restore engine, to restore, when a system recovers, the stored data set to volatile memory; and
a notify engine, to notify a data consumer that the stored data set is available for use.

9. The system of claim 8, wherein the set of volatile memory identified is associated with a computer process.

10. The method of claim 8, wherein the system event is one of a power outage, a system shutdown, a system failure, a system sleep, or a system hibernation.

11. The system of claim 8, wherein the write engine writes an amount of memory that may be stored under auxiliary power.

12. The system of claim 11, wherein the write engine writes the set of volatile memory to stable storage begins writing based on an amount of power measured in the auxiliary power source.

13. The system of claim 8, wherein the system event is a notification of an amount of auxiliary power available to write data.

14. A computer program product for preserving volatile memory across a computer system disruption, the computer program product comprising:
a non-transitory tangible computer readable storage medium, said tangible computer readable storage medium comprising computer readable program code embodied therewith, said computer readable program code comprising program instructions that, when executed, cause a processor to:
identify a set of volatile memory, the set of volatile memory representing a portion of data in volatile memory to preserve during a system disruption;
receive a system event, the system event indicating that a computer system disruption will occur and that the set of volatile memory is to be written to a stable storage device; and
write the set of volatile memory to the stable storage device to create a stored data set.

15. The product of claim 14, further comprising computer program code to, when executed by a processor:
restore, when a system recovers, the stored data set to volatile memory; and
notify a data consumer that the stored data set is available for use.

16. The product of claim 13, wherein the set of volatile memory identified is associated with a computer process.

17. The product of claim 13, wherein the system event is one of a power outage, a system shutdown, a system failure, a system sleep, or a system hibernation.

18. The product of claim 13, wherein writing the set of volatile memory to the stable storage writes an amount of memory that may be stored under auxiliary power source.

19. The product of claim 18, wherein writing the set of volatile memory to stable storage begins writing based on an amount of power measured in the auxiliary power source.

20. The product of claim 13, wherein the system event is a notification of an amount of auxiliary power available to write data.
